(19) United States
(12) Patent Application Publication
(10) Pub. No.: US 2009/0126693 A1
(43) Pub. Date: May 21, 2009

(54) Fuel System Comprising A Fuel Reserve Container And A Retaining Trough

(75) Inventors: Paul Plissart, Tervuren (BE); Jules-Joseph Van Schaftingen, Wavre (BE)

Correspondence Address: Solvay;c/o B. Ortego - IAM-NAFTA, 3333 Richmond Avenue, Houston, TX, 77098-3099, US

(73) Assignee: Inergy Automotive Systems Research, Brussels (BE)

(21) Appl. No.: 12/064,743

(22) PCT Filed: Sep. 1, 2006
(86) PCT No.: PCT/EP2006/065904

§ 371 Date: Aug. 18, 2008

(30) Foreign Application Priority Data
Sep. 2, 2005 (FR) 05.08995

(51) Int. Cl. F02M 37/18; F02M 37/04

(52) U.S. Cl. 123/495; 137/565.29

(57) ABSTRACT

Fuel system intended for a heat engine and comprising a fuel tank, a pipe for filling the tank and a pump for supplying the engine with fuel. The pump is supplied with fuel from a fuel reserve container, the fuel system additionally including a retaining trough independent of the reserve container, positioned so that the reserve container is supplied with fuel from the trough and having a wall defining a volume emerging at the upper part through an opening in the tank. The wall forms a continuous envelope separating the volume of the trough from the rest of the tank.

The invention relates to the supply of internal combustion engines with liquid fuels. It relates more specifically to a fuel system intended for such engines, it being possible for this fuel system to be applied without distinction to engines supplied with volatile liquid fuels or to engines supplied with heavy liquid fuels such as those sometimes called, according the countries and regions, by the terms diesel, on-road diesel or gas oil.

In heat engines, in particular in automotive vehicles, the fuel system currently includes, apart from a tank for storing fuel, a certain number of accessories. Among these accessories, are to be found, among others, fuel pumps and filters.

As regards pumps/filters, the tendency is to incorporate them into a single module which is actually fixed inside the fuel tank as described in application EP 0 758 589 in the name of Solvay for example.

One of the requirements that a fuel tank must fulfil is that of supplying an engine with fuel even under severe travelling conditions, such as climbing an incline, negotiating a bend with an almost empty tank etc. Now, under these conditions, the fuel pump must be regularly supplied with fuel, even if the tank contains no more than a small quantity of fuel.

It is in order to satisfy this type of requirement that it is known to resort to a fuel reserve container serving to capture and retain fuel so as to prevent the pump from unpriming and to guarantee that the pump will prime after the vehicle has run out of fuel.

Two types of fuel reserve container are known. The first is a retaining trough independent of the pump supply, in the form of a partition formed when the tank is blow-moulded, either by the shape of a blow-moulding mould or by introducing a component into the tank, possibly in the form of a spiral, which traps fuel when cornering. The second is a reserve container hydraulically connected to the pump or at least to a jet pump generally inserted when the assembly formed of the pump and filter is inserted into the tank, but sometimes also when the fuel tank is blow-moulded.

The disadvantage of the first type is that the wall of the trough has a limited height in order to guarantee passage of fuel from the tank to the trough, so that the quantity of fuel stored in this trough can sometimes be too small and can cause breakdowns.

The second type of tank has the disadvantage that the size of the reserve container is limited by the size of the orifice made in the tank and though which the reserve container is inserted into the tank.

In addition, an attempt is made to reduce the height of current tanks so as to satisfy new vehicle architectures. This also has the effect of limiting the size of the components inserted in the fuel tank, in particular pumps and fuel reserve containers.

The object of the present invention is consequently to provide a fuel system having an improved architecture, aimed at increasing the total capacity of the fuel reserve container, to reduce the size of the reserve container connected to the pump and, on account of this, the size of the orifice for introducing it as required, which is particularly valuable in the case of thin tanks for which only an orifice of reduced dimensions is available.

A thin tank is understood to denote a tank of which the height, measured along a vertical axis, is generally between 100 and 300 mm, and preferably 150 and 250 mm.

To this end, the present invention relates to a fuel system intended for a heat engine and comprising a fuel tank, a pipe for filling the tank, a pump for supplying the engine with fuel, said pump being supplied with fuel from a fuel reserve container, the fuel system additionally including a retaining trough independent of the reserve container, positioned so that the reserve container is supplied with fuel from the trough and having a wall defining a volume emerging in the upper part through an opening in the tank, said wall forming a continuous envelope separating the volume of the trough from the rest of the tank.

The fuel system according to the invention is suitable without distinction for heat engines supplied with volatile liquid fuels or for engines supplied with heavy liquid fuels as mentioned above. In the present description, the fuel system is an assembly of elements which are intended to be incorporated in a motor vehicle or an installation with a stationary engine. The self-propelled vehicle may be a motor vehicle (car, truck, motorcycle, riverboat, maritime vessel or an aeroplane, for example) or a vehicle confined to a track (for example a railway motor coach). The stationary engine installation may for example comprise the engine of an electricity generating unit or the engine of a machine tool.

Fuel is intended to mean a hydrocarbon that is suitable for supplying internal combustion engines. The expression “liquid hydrocarbon” denotes a hydrocarbon which, under normal conditions in which an engine is used, exists in the liquid state in the fuel tank of the fuel system.

The expression “volatile liquid hydrocarbon” denotes a liquid hydrocarbon (according to the definition stated above) which has a saturated vapour pressure greater than 0.1 bar at 293° K (20° C.). Volatile liquid hydrocarbons commonly used for supplying heat engines of motor vehicles are those sold commercially under the name “petrol” and are intended for spark ignition heat engines called “internal combustion engines”.

The expression “heavy liquid hydrocarbon” denotes a liquid hydrocarbon which has a saturated vapour pressure less than 0.1 bar at 293° K (20° C.). Heavy liquid hydrocarbons commonly used for supplying heat engines of motor vehicles are those sold commercially under the names “gas oil” or “diesel fuel” and intended for compression ignition heat engines, operating according to the diesel cycle.

According to the invention, the components of the fuel system are made of a material that is compatible with each of the liquid hydrocarbons that are likely to be encountered. This material must be chemically inert both to volatile liquid hydrocarbons and to heavy liquid hydrocarbons at pressures and temperatures at which they are normally used. It may be a plastic or a metal. Components of the system according to the invention may also be mixed, that is to say comprise metal parts and plastic parts.

Thermoplastic materials give good results within the scope of the invention, in particular by reason of advantages of weight, mechanical strength and chemical resistance, and ease of processing, in particular when the components of the system have complex shapes.

A thermoplastic material denotes any thermoplastic polymer, including thermoplastic elastomers, as well as mixtures thereof. The term “polymer” denotes homopolymers as well as copolymers (in particular binary or ternary). Examples of such copolymers are, in a non-limiting manner: random copolymers, linear block copolymers, other block copolymers and graft copolymers.

Any type of thermoplastic polymer or copolymer having a melting point below the decomposition temperature is suitable. Synthetic thermoplastics which have a melting range spread over at least 10° Celsius are particularly well suited. Examples of such materials, are those having a polydispersion of their molecular mass.

In particular, use can be made of polyolefins, polyvinyl halides, thermoplastic polyesters, polyketones, polyamides and copolymers thereof. A mixture of polymers and copolymers can also be used, as well as a mixture of polymeric materials with inorganic, organic and/or natural fillers, as for example, but not in a limiting manner: carbon, salts and other inorganic derivatives, natural fibres, glass fibres and polymeric fibres. It is also possible to use multilayer structures consisting of stacked cohesive layers comprising at least one of the polymers or copolymers described above.

Polyvinyl halides and polyolefins are generally preferred. A polymer that is often employed is polyethylene. Excellent results have been obtained with high density polyethylene (HDPE). In a known manner, the impermeability of this material to volatile hydrocarbons can be improved by surface treatment (fluorination, sulphonation etc) and/or by making use of a barrier layer (based for example on polyamide (PA) or a vinyl alcohol polymer [a homopolymer (PVOH) or an ethylene-vinyl alcohol copolymer (EVOH)].

In a preferred manner, at least the tank and filling pipe of the system according to the invention are made of a thermoplastic and preferably comprise HDPE. In a more particularly preferred manner, the tank and filling pipe are multilayer structures including at least one layer based on HDPE and at least one layer based on EVOH (the terms “based on” signifying “mainly consisting of”) it being understood that these layers may include other polymers and/or additives in a minor quantity (by weight). The pump of the fuel system according to the invention can also have a casing made of plastic.

According to the invention, the fuel pump is supplied with fuel from a fuel reserve container.

According to the invention, the fuel system additionally includes a retaining trough independent of the fuel reserve container.

Such a fuel reserve container is also called a calming trough and enables a fuel reserve container to be established for supplying the fuel pump.

According to the invention, the holding tank has a wall defining a volume emerging at the top through an opening in the tank The wall moreover forms a continuous envelope separating the volume of the retaining trough from the rest of the tank.

The retaining trough is preferably made in one piece with the wall of the bottom of the tank.

It is possible in this way to obtain improved leaktightness and to overcome any problems of fixing the retaining trough and holding it in relation to the tank.

In other words, it is possible to avoid having to fix the retaining trough onto the tank, resulting in a particularly reliable and simple system when the retaining trough is fastened to the wall of the bottom of the tank by being moulded in one piece with this bottom wall.

In a particular embodiment, the fuel reserve container is positioned outside the volume defined by the wall of the retaining trough.

In a preferred manner, the retaining trough is supplied with fuel by a secondary suction device independent of a main suction device of the fuel reserve container.

The suction device of the trough is able to deliver fuel into the retaining trough through the opening through which the trough emerges into the tank.

Advantageously, the main as well as the secondary suction device is a jet pump.

Preferably, the main as well as the secondary suction device is supplied via a pressure regulator.

The delivery rate of the jet pump constituting the main suction device is preferably chosen so that the quantity of fuel delivered by this jet pump compensates for the quantity taken off, consumed by the fuel pump and guaranteeing a minimum fuel level in the retaining trough, so that the fuel pump does not refuse to prime.

Preferably, the tank has a filling pipe ending above the fuel reserve container/retaining trough, which makes it possible to fill the reserve container/retaining trough with a small quantity of fuel, since all the fuel introduced into the filling pipe starts to fill the reserve container/retaining trough before filling the rest of the tank.

In a particular embodiment, the fuel reserve container is a screen which also has the function of filtering the fuel sucked up, so as prevent fouling of the pump. The screen generally consists of a flexible pocket connected to the pump and of which the envelope is made of a material that is porous to fuel but through which any impurities contained in the fuel cannot pass.

The flexible nature of the screen has the advantage of permitting movement inside the fuel tank which makes it easier to recover the fuel necessary for supplying the pump from the tank.

In a preferred manner, the pump and fuel reserve container are mounted horizontally inside the tank so as to reduce the working height of the fuel tank.

The fuel tank preferably also includes a fuel filter.

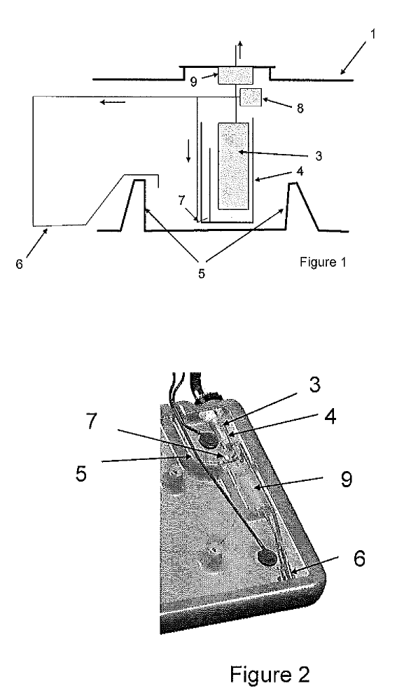

The present invention is illustrated in a non-limiting manner by FIGS. 1 and 2 which constitute schematic diagrams of some preferred variants of the present invention.

FIG. 1 shows an assembly consisting of a pump (3), a pressure regulator (8) and a fuel filter (9) inserted in a fuel tank (1), the pump (3) being positioned inside a fuel reserve container (4). The reserve container (4) is located in a space defined by a retaining trough (5) and is supplied with fuel coming from the trough (5) by a jet pump (7). A suction device (6) which is also a jet pump supplies the retaining trough (5) with fuel coming from the fuel tank (1) outside the space defined by said trough (5).

FIG. 2 shows a reservoir with an overall height of 50 to 150 mm with a reserve container (4) of a reduced size with a capacity of 200 ml. This reserve container (4) is resupplied from a retaining trough (5) of which the geometry is obtained when the tank is blow-moulded, and which possesses no interruption of the wall. The retaining trough (5) has an opening permitting communication with the tank (1). A module mounted horizontally during assembly contains two jet pumps (6 and 7) supplying the retaining trough (5) and the reserve container (4) respectively, drawing from the zones corresponding to rolled portions rising with a left hand or right hand curve, a fuel filter (9) and a connected reserve container (4) containing a pump (3). Once the fuel filter (9) is introduced into the tank, it at least partially obstructs communication between the retaining trough (5) and the tank (1), which means that advantageously the retaining trough (5) will not be able to be emptied during sudden fuel movements.

1. A fuel system intended for a heat engine and comprising a fuel tank (1), a pipe (2) for filling the tank (1), a pump (3) for supplying the engine with fuel, said pump (3) being supplied with fuel from a fuel reserve container (4), the fuel system additionally including a retaining trough (5) independent of the reserve container (4), positioned so that the reserve container (4) is supplied with fuel from the trough (5) and having a wall defining a volume emerging at the top through an opening in the tank (1), said wall forming a continuous envelope separating the volume of the trough (5) from the rest of the tank (1).

2. The fuel system according to claim 1, wherein the tank (1) has a bottom wall and wherein the trough (5) is made in one piece with the bottom wall of the tank (1).

3. The fuel-Fuel system according to claim 1, wherein the reserve container (4) is positioned outside the volume defined by the wall of the trough (5).

4. The fuel system according to claim 1, wherein the trough (5) is supplied with fuel by a secondary suction device (6) independent of a main suction device (7) of the reserve container (4).

5. The fuel system according to claim 4, wherein the main (7) and secondary (6) suction devices are jet pumps.

6. The fuel system according to claim 1, wherein one end of the filling pipe (2) is situated above the fuel reserve container (4) and/or the trough (5).

7. The fuel system according to claim 1, wherein the wall of the trough (5) is extended by a complementary part.

8. The fuel system according to claim 1, wherein the reserve container (4) is a screen.

9. The fuel system according to claim 1, wherein the pump (3) and the reserve container (4) are mounted horizontally inside the tank (1).

10. The fuel system according to claim 1, said fuel system including a fuel filter (9) and said filter (9) obstructing at least partially the opening permitting communication between the trough (5) and the tank (1).
